(19) United States
(12) Patent Application Publication
(10) Pub. No.: US 2026/0123789 A1
(43) Pub. Date: May 7, 2026

(54) COOKING APPARATUS

(71) Applicant: NINGBO FOTILE KITCHEN WARE CO.,LTD., Ningbo (CN)

(72) Inventors: Kejie ZHU, Ningbo (CN); Zhejun WEI, Ningbo (CN); Fan CAI, Ningbo (CN); Ting YU, Ningbo (CN); Anlin CHEN, Ningbo (CN); Wentao NING, Ningbo (CN); Chunyang ZUO, Ningbo (CN); Lange MIAO, Ningbo (CN); Jingbo RU, Ningbo (CN)

(21) Appl. No.: 19/438,973

(22) Filed: Jan. 2, 2026

Related U.S. Application Data
(63) Continuation of application No. PCT/CN2025/078407, filed on Feb. 21, 2025.

(30) Foreign Application Priority Data
Aug. 30, 2024 (CN) 202411205301.8

(51) Int. Cl. A47J 36/38; A47J 37/06

(52) U.S. Cl. CPC A47J 36/38; A47J 37/0641

(57) ABSTRACT

A cooking apparatus is provided. The cooking apparatus includes a heat-gathering unit and an external discharge unit, the heat-gathering unit includes an external discharge connecting member and is provided with a cooking cavity formed on an inner side of the external discharge connecting member. The external discharge unit includes a flow guide member, the flow guide member is connected to the external discharge connecting member and is provided with an external discharge channel. The exhaust unit further includes a baffle member located in the external discharge channel. The baffle member is provided with an external leakage gap, and the external leakage gap is in communication with the cooking cavity with the external discharge channel; and/or, the external leakage gap is in communication with the exhaust discharge channel with an outside of the cooking apparatus.

### CROSS-REFERENCE TO RELATED APPLICATIONS

This application is a continuation of international patent application No. PCT/CN2025/078407, filed on Feb. 21, 2025, which claims priority to Chinese patent application No. 202411205301.8, filed on Aug. 30, 2024, and titled “COOKING APPARATUS”. The contents of the above identified applications are hereby incorporated herein in their entireties by reference.

### TECHNICAL FIELD

The present disclosure relates to the field of kitchenware technology, and in particular, to a cooking apparatus.

### BACKGROUND

Baking and cooking equipment such as ovens and steam ovens generates circulating hot air flows through a hot air unit to heat and cook food materials. The hot air flows first flow out of the hot air unit, then pass through a hot air baffle to enter a cooking cavity. Subsequently, the hot air flows turn around, flow back toward the hot air baffle and pass through the hot air baffle again. A circulation process is completed when the hot air flows return to the hot air unit, and the food is cooked after the above circulation process is repeated multiple times.

It is generally desirable that the hot air flows remain in the baking and cooking equipment for as long as possible, so that the hot air flows can perform multiple rounds of circulation to fully utilize the heat carried by the hot air flows, and avoid the hot air unit from frequently heating the air to increase power consumption. However, the current difficulty lies in the inability to balance safety and multiple circulations of the hot air flows. Restricting the outward discharge of the hot air flows can increase the residence time and circulation times of the hot air flows in the baking and cooking equipment, but since a large amount of hot air flows cannot be discharged and accumulate in the cooking cavity, the air pressure in the cooking cavity increases sharply, and the user is highly likely to be scalded by the hot air flows when opening the cooking cavity to take food.

### SUMMARY

In view of above, the present disclosure provides a cooking apparatus that allows hot air flows to be discharged outward while limiting an outward discharge rate of the hot air flows, in order to balance a safety during food taking and an increase of circulation times and residence time of the hot air flows in the cooking apparatus.

The present disclosure provides a cooking apparatus. The cooking apparatus includes a heat-gathering unit and an external discharge unit. The heat-gathering unit includes an external discharge connecting member and is provided with a cooking cavity formed on an inner side of the external discharge connecting member. The external discharge unit includes a flow guide member and a baffle member. The flow guide member is connected to the external discharge connecting member and is provided with an external discharge channel. The external discharge connecting member and the flow guide member form an exhaust path. The baffle member is arranged on the exhaust path and is provided with an external leakage gap. The external leakage gap is in communication with the cooking cavity and the external discharge channel; and/or, the external leakage gap is in communication with the external discharge channel and an outside of the cooking apparatus.

In some embodiments, the external discharge connecting member is provided with an air outlet hole in communication with the external discharge channel. The baffle member includes a ventilation cover covering the air outlet hole, the ventilation cover includes a baffle side wall protruding from the inner side of the external discharge connecting member. The external leakage gap includes a first leakage gap formed on the baffle side wall of the ventilation cover, and the first leakage gap is in communication with the cooking cavity and the air outlet hole.

In some embodiments, the cooking apparatus further includes a hot air unit. A part of the baffle side wall adjacent to the hot air unit forms a rear part of the baffle side wall. A part of the baffle side wall away from the hot air unit forms a front part of the baffle side wall. The first leakage gap is entirely formed on the front part of the baffle side wall. Alternatively, the first leakage gap includes a rear leakage gap formed on the rear part of the baffle side wall and a front leakage gap formed on the front part of the baffle side wall, and an opening size of the front leakage gap is greater than that of the rear leakage gap.

In some embodiments, the external discharge connecting member includes a front end and a rear end. The front end of the external discharge connecting member is arranged away from the hot air unit. The rear end of the external discharge connecting member is arranged adjacent to the hot air unit. A distance between the air outlet hole and the front end of the external discharge connecting member is greater than a distance between the air outlet hole and the rear end of the external discharge connecting member.

In some embodiments, the heat-gathering unit further includes a first side plate and a second side plate. The first side plate, the external discharge connecting member and the second side plate are connected in sequence to enclose and form the cooking cavity. A distance between the first side plate and the air outlet hole is defined as a₁, a distance between the second side plate and the air outlet hole is defined as a₂, and the distance a₁ between the first side plate and the air outlet hole is not equal to the distance a₂ between the second side plate and the air outlet hole.

In some embodiments, the ventilation cover further includes a sinking bottom wall arranged opposite to the air outlet hole. The baffle side wall extends along an outer peripheral edge of the sinking bottom wall and encloses with the sinking bottom wall to form a purification cavity, the purification cavity is in communication with the air outlet hole and the first leakage gap, and a purification member is arranged in the purification cavity.

In some embodiments, the flow guide member includes a buffer pipe connected to the external discharge connecting member. The buffe pipe includes a buffer cavity in communication with the cooking cavity. The buffer cavity is a part of the outer exhaust channel. The baffle member includes a bent pipe connected to and in communication with the buffer pipe in a bent manner. The external leakage gap includes a second leakage gap formed in the bent pipe. The second leakage gap is in communication with the buffer cavity and the outside of the cooking apparatus.

In some embodiments, the flow guide member further includes a pipe connecting member connected to the buffer pipe in a bent manner. An end of the pipe connecting member away from the buffer pipe is connected to the external discharge connecting member. The external discharge channel further includes a waste gas flow passage formed in the pipe connecting member. Two ends of the waste gas flow passage are in communication with the buffer cavity and the cooking cavity, respectively.

In some embodiments, a purification member is arranged inside the waste gas flow passage.

In some embodiments, the buffer pipe includes a first pipe connecting portion and a second pipe connecting portion. The external discharge connecting member and the bent pipe are connected to the first pipe connecting portion and the second pipe connecting portion, respectively. A distance between the buffer cavity and the external discharge connecting member increases from the first pipe connecting portion to the second pipe connecting portion.

In some embodiments, an angle is formed between an extending direction of the buffer cavity and an extending direction of the external discharge connecting member. The angle is in a range of greater than or equal to 3 degrees to less than or equal to 8 degrees.

In some embodiments, the buffer pipe includes a first pipe wall and a second pipe wall arranged at intervals. The first pipe wall is connected to the external discharge connecting member and is provided with a side inlet for communicating the buffer cavity with the cooking cavity. A distance between the first pipe wall and the second pipe wall is less than a width of the first pipe wall or a width of the second pipe wall; and/or, a width of the first pipe wall or a width of the second pipe wall is not less than twice a diameter of the side inlet.

In some embodiments, the bent pipe extends in a direction away from the external discharge connecting member.

In some embodiments, the second leakage gap runs through the bent pipe and forms an exhaust port, and a cross-sectional area of the second leakage gap decreases from the buffer pipe to the exhaust port.

In some embodiments, the heat-gathering unit further includes a hot air baffle connected to the external discharge connecting member. A hot air unit and a purification member are arranged on one side of the hot air baffle and the cooking cavity is formed on the other side of the hot air baffle.

Details of one or more embodiments of the present disclosure are presented in the attached drawings and descriptions below. And other features, purposes and advantages of the present disclosure will become apparent from the description, drawings and claims.

### BRIEF DESCRIPTION OF THE DRAWINGS

For a better description and illustration of embodiments and/or examples of those disclosures disclosed herein, reference may be made to one or more attached drawings. Additional details or examples used to describe the drawings should not be considered as limiting the scope of any of the disclosed disclosures, currently described embodiments and/or examples, and currently understood best modes of these disclosures.

FIG. 1 is a front view of a cooking apparatus according to an embodiment of the present disclosure.

FIG. 2 is a sectional view of the cooking apparatus in FIG. 1 along A-A line.

FIG. 3 is a partial enlarged view of the cooking apparatus in FIG. 2.

FIG. 4 is a schematic view of an external discharge unit of the cooking apparatus according to an embodiment of the present disclosure.

FIG. 5 is a perspective view of the cooking apparatus according to an embodiment of the present disclosure.

### REFERENCE SIGNS

10 represents a heat-gathering unit; 11 represents a hot air baffle; 111 represents an air return hole; 112 represents a side air outlet hole; 1131 represents a first side flange; 1132 represents a top flange; 1133 represents a second side flange; 1134 represents a bottom flange; 1135 represents a first inclined flange; 1136 represents a second inclined flange; 1137 represents a third inclined flange; 1138 represents a fourth inclined flange; 12 represents an cooking-chamber assembly; 121 represents a first side plate; 122 represents an external discharge connecting member; 1221 represents an air outlet hole; 123 represents a second side plate; 124 represents a bottom plate; 125 represents a cooking cavity; 20 represents an external discharge unit; 21 represents a flow guide part; 211 represents a buffer pipe; 2111 represents a buffer cavity; 2112 represents a first pipe connecting part; 2113 represents a second pipe connecting portion; 2114 represents a first pipe wall; 2115 represents a second pipe wall; 2116 represents a side inlet; 212 represents a pipe connecting member; 2121 represents a waste gas flow passage; 221 represents a ventilation cover; 2211 represents a first leakage gap; 2212 represents a baffle side wall; 2213 represents a rear side; 2214 represents a front side; 2215 represents a sinking bottom wall; 2216 represents a purification cavity; 222 represents a bent pipe; 2221 represents a second leakage gap; 2222 represents an exhaust port; 30 represents a hot air unit; 31 represents a fan; 32 represents a heating element; 40 represents a back plate; 41 represents a hot air cavity; 51 represents a first purification member; 52 represents a second purification member; and 53 represents a ventilation hole.

### DETAILED DESCRIPTION

The technical solutions in the embodiments of the present disclosure will be clearly and completely described below with reference to the accompanying drawings in the embodiments of the present disclosure. It is obvious that the described embodiments are only a part of the embodiments, but not all of the embodiments. All other embodiments obtained by a person of ordinary skill in the art based on the embodiments of the present disclosure without creative efforts shall fall within the protection scope of the present disclosure.

Unless otherwise defined, all technical and scientific terms used in the specification of the present disclosure have the same meaning as commonly understood by those skilled in the art to which the present disclosure belongs. Terms used in the specification of the present disclosure are used only for the purpose of describing specific embodiments and are not intended to limit the present disclosure. The term “and/or” as used in the specification of the present disclosure includes any and all combinations of one or more of the relevant listed items.

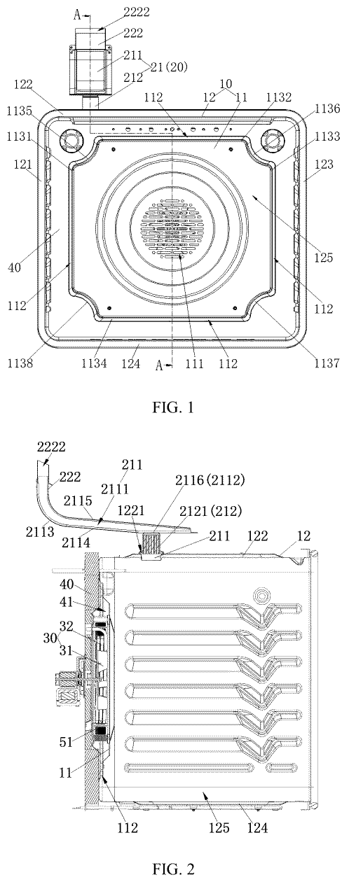

The present disclosure provides a cooking apparatus, such as an oven, a steam oven, or the like. Referring to FIGS. 1 and 2, the cooking apparatus includes a heat-gathering unit 10, a back plate 40, and a hot air unit 30. The heat-gathering unit 10 includes a hot air baffle 11 and an cooking-chamber assembly 12. The hot air baffle 11 is provided with a blowing side and a leeward side arranged opposite to each other. The cooking-chamber assembly 12 and the back plate 40 are located on the blowing side and the leeward side of the hot air baffle 11, respectively. The blowing side and the cooking-chamber assembly 12 adjacent to form a cooking cavity 125. The cooking cavity 125 is configured to place food materials and serves as a space where hot air flows heat the food materials to cook them. A hot air cavity 41 is formed between the leeward side and the back plate 40. The hot air unit 30 is arranged in the hot air cavity 41, and the hot air cavity 41 is configured as a space for generating hot air flows. The hot air baffle 11 is provided with blowing holes and air return holes 111, which penetrate through the blowing side and the leeward side, thereby communicating the cooking cavity 125 with the hot air cavity 41.

The hot air unit 30 includes a fan 31 rotatably arranged in the hot air cavity 41. The hot air unit 30 further includes a heating element 32 arranged in the hot air cavity 41. A rotation axis of the fan 31 passes through the hot air baffle 11. The heating element 32 may be configured as a heating tube circumferentially surrounding an outer side of the fan 31 along the rotation axis of the fan 31. The cooking-chamber assembly 12 is a hollow prismatic structure with an inner passage. An extending direction of the inner passage is the same as that of the rotation axis of the fan 31. The hot air baffle 11 is located at one end of the inner passage, so that the inner wall surface of the inner passage and the blowing side of the hot air baffle 11 adjacent to form the cooking cavity 125. The other end of the inner passage forms an inner container opening that allows users to take food materials out of or put them into the cooking cavity 125.

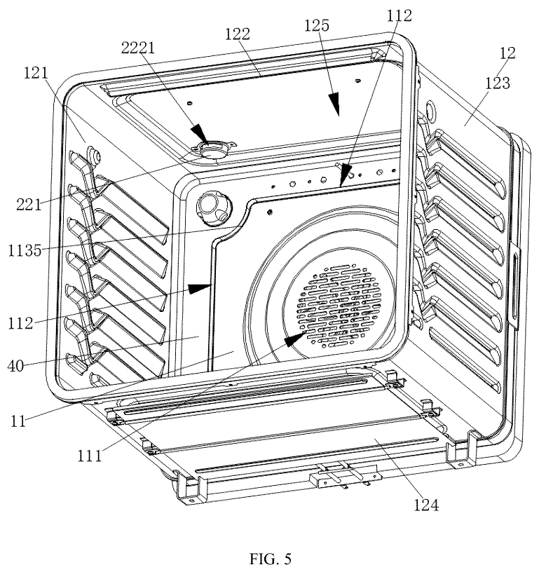

Referring to FIG. 1 and FIG. 5, the hot air baffle 11 includes an air return portion and a baffle portion. The air return holes 111 are located on the air return portion. The baffle portion is connected to an outer peripheral edge of the air return portion. The air return portion and the baffle portion are parallel or coplanar. A rotation axis of the fan 31 vertically passes through the air return portion of the hot air baffle 11. The cooking-chamber assembly 12 includes a first side plate 121, a top plate, a second side plate 123, and a bottom plate 124 sequentially arranged along a circumferential direction of the rotation axis of the fan 31. The inner wall surface of the inner passage includes a side surface of the first side plate 121 toward the second side plate 123, a side surface of the top plate toward the bottom plate 124, a side surface of the second side plate 123 toward the first side plate 121, and a side surface of the bottom plate 124 toward the top plate. The inner wall surface of the cooking-chamber assembly 12 is defined as the inner wall surface of the inner passage.

When the cooking apparatus is used to bake food materials, the hot air unit 30 is first started to operate. The fan 31 rotates and disturbs the air in the hot air cavity 41, and at the same time, the heating element 32 heats the air thrown out by the fan 31 to form hot air flows. The hot air flows pass through the hot air baffle 11 through the blowing holes and then enter the cooking cavity 125. After flowing a certain distance in the cooking cavity 125, the hot air flows turn around and flow back toward the hot air baffle 11. The returned hot air flows enter the hot air cavity 41 through the hot air baffle 11 via the air return holes 111 as return air flows, and then the return air flows become hot air flows again under the disturbance of the fan 31. The hot air flows repeat the above process and circulate multiple times between the hot air cavity 41 and the cooking cavity 125, thereby heating the food materials for many times. Usually, the return air flow still carries a lot of heat, which means that in most cases, after the return air flow enters the hot air cavity 41, it only needs to be disturbed again by the fan 31 to become hot air flow again without being reheated. Only after the hot air flow circulates many times and the temperature of the return air flow returning to the hot air cavity 41 drops below a certain temperature, it is necessary to reheat a part of the return air flow to make it hot air flow again.

Therefore, an operation of the hot air unit 30 is as follows. During a complete food cooking process, the fan 31 rotates continuously to provide power for the circulating flow of the hot air flow; the heating element 32 is started to operate intermittently. The heating element 32 stops operating after heating the air in the hot air cavity 41 once, the hot air flow circulates multiple times between the hot air cavity 41 and the cooking cavity 125 during a period when the heating element 32 is stopped. Until the temperature of the air in the hot air cavity 41 and the return air flow entering the hot air cavity 41 drops below a certain temperature, the heating element 32 operates again. In this way, not only is the heat of the hot air flow fully and efficiently utilized, but the power consumption of the heating element 32 is also reduced. The heating element 32 does not need to operate continuously for a long time, and the fan 31 can be prevented from being roasted for a long time. After the cooking is completed, the remaining hot air in the cooking cavity 125 and the hot air cavity 41 will be discharged out of the cooking apparatus.

In an embodiment, the hot air flow circulates between the hot air cavity 41 and the cooking cavity 125 according to a preset circulation path, which includes a centrifugal path located in the hot air cavity 41, a blowing path located in the cooking cavity 125, and an air return path located in the cooking cavity 125. The centrifugal path refers to a path along which the return air flow, after passing through the hot air baffle 11 via the air return holes, 111 is driven radially outward the fan 31 under the disturbance of the fan 31. The blowing path refers to a path along which the hot air flow, propelled outward the fan 31, passes through the hot air baffle 11 via the blowing holes and flows away from the hot air baffle 11. The air return path refers to a path along which the hot air flow turns around and flows back in the cooking cavity 125, to flow toward the air return holes 111 along a direction adjacent to the hot air baffle 11. The hot air flows for cooking food materials are mainly those on the blowing path and the air return path.

Furthermore, the cooking apparatus of the present disclosure further includes an external discharge unit 20. The heat-gathering unit 10 includes an external discharge connecting member 122 provided with an air outlet hole 1221. The cooking cavity 125 is formed on an inner side of the external discharge connecting member 122 and is in communication with the air outlet hole 1221. The external discharge unit 20 includes a flow guide member 21 connected to the external discharge connecting member 122. The flow guide member 21 includes an external discharge channel which is in communication with the outside of the cooking apparatus and the air outlet hole 1221, so the external discharge connecting member 122 and the flow guide member 21 form an exhaust path, which allows the hot air flow to be discharged outside of the cooking apparatus from the cooking cavity 125. The hot air flow can be discharged intensively along the exhaust path after the food cooking is completed, or can be discharged intermittently along the exhaust path for multiple times during the food cooking process. In an embodiment, a part of the hot air flow is discharged along the exhaust path after circulating several times between the hot air cavity 41 and the cooking cavity 125, then the hot air unit 30 continues to supplement and generate hot air flow, and after the hot air flow circulates several times again between the hot air cavity 41 and the cooking cavity 125, a part of the hot air flow is discharged along the exhaust path again.

In some embodiments, the top plate of the cooking-chamber assembly 12 is provided with the air outlet hole 1221 which is in communication with the cooking cavity 125, and the top plate serves as the external discharge connecting member 122 of the heat-gathering unit 10. Referring to FIGS. 1 and 2, the flow guide member 21 is connected to the outer side of the top plate, the cooking cavity 125 is formed on the inner side of the top plate. The outer side of the top plate, as the outer side of the external discharge connecting member 122, specifically refers to the side of the top plate away from the bottom plate 124. The inner side of the top plate, as the inner side of the external discharge connecting member 122, specifically refers to the side of the top plate adjacent to the bottom plate 124. The external discharge connecting member 122 of the heat-gathering unit 10 can also be the first side plate 121 or the second side plate 123. When the first side plate 121 is used as the external discharge connecting member 122, the first side plate 121 is provided with the air outlet hole 1221 which is in communication with the cooking cavity 125, the inner side of the external discharge connecting member 122 is the side of the first side plate 121 adjacent to the second side plate 123, the flow guide member 21 is connected to the outer side of the first side plate 121, and the outer side of the first side plate 121, as the outer side of the external discharge connecting member 122 at this time, refers to the side of the first side plate 121 away from the second side plate 123. When the second side plate 123 is used as the external discharge connecting member 122, the second side plate 123 is provided with the air outlet hole 1221, which is in communication with the cooking cavity 125. The inner side of the external discharge connecting member 122 is the side of the second side plate 123 adjacent to the first side plate 121, the flow guide member 21 is connected to the outer side of the second side plate 123, and the outer side of the second side plate 123, as the outer side of the external discharge connecting member 122 at this time, refers to the side of the second side plate 123 away from the first side plate 121.

In an embodiment, it is necessary to discharge the hot air flow from the cooking cavity 125, otherwise, the hot air flow will remain in the cooking apparatus for a long time and continuously absorb heat, resulting in a large amount of high-temperature hot air accumulating in the cooking cavity 125, and the air pressure in the cooking cavity 125 increasing significantly. When the user opens the cooking cavity 125 and tries to take the food, the user is likely to be burned by the high-temperature and high-pressure hot air in the cooking cavity 125 rushing towards the face. However, due to the existence of the air outlet hole 1221 and the external discharge channel, it is difficult for the hot air flow to remain in the cooking apparatus for a long time. In most cases, the hot air flow is discharged outward through the flow guide member 21 after only a smaller number of circulations between the hot air cavity 41 and the cooking cavity 125. The heat carried by the hot air flow is not efficiently utilized, and the temperature and the amount of hot air in the cooking cavity 125 fluctuate drastically. In order not to affect the cooking efficiency of the food materials, the heating element 32 has to be started frequently or even run continuously to continuously heat the air thrown out by the fan 31 to continuously supplement the hot air flow into the cooking cavity 125. Therefore, the power consumption of the existing cooking apparatus is relatively high, and a large amount of power consumption is used for the hot air unit 30 to generate hot air flow.

In view of above, the improvement of the cooking apparatus of the present disclosure includes: the external discharge unit 20 further includes a baffle member, which is arranged on the exhaust path formed by the external discharge connecting member 122 and the flow guide member 21 and is provided with an external leakage gap, the external leakage gap is in communication with the cooking cavity 125 and the external discharge channel; and/or, the external leakage gap is in communication with the external discharge channel and the outside of the cooking apparatus. In this way, the cooking cavity 125 is in communication with the outside of the cooking apparatus through the external discharge channel and the external leakage gap, thereby allowing the hot air flow to be discharged outside the cooking apparatus along the exhaust path. A baffle member arranged on the exhaust path can block and disturb the hot air flow, slow down the discharge speed of the hot air flow along the exhaust path, reduce the amount of hot air flow discharged outward within the same time, prolong a residence time of the hot air flow in the cooking apparatus, increase the number of circulations of the hot air flow between the hot air cavity 41 and the cooking cavity 125, improve the utilization rate of the heat carried by the hot air flow, avoid the hot air flow being discharged too fast and too early, reduce the temperature fluctuation range in the cooking cavity 125, so that the heating unit does not need to be started frequently, and reduce the power consumption of the hot air unit 30.

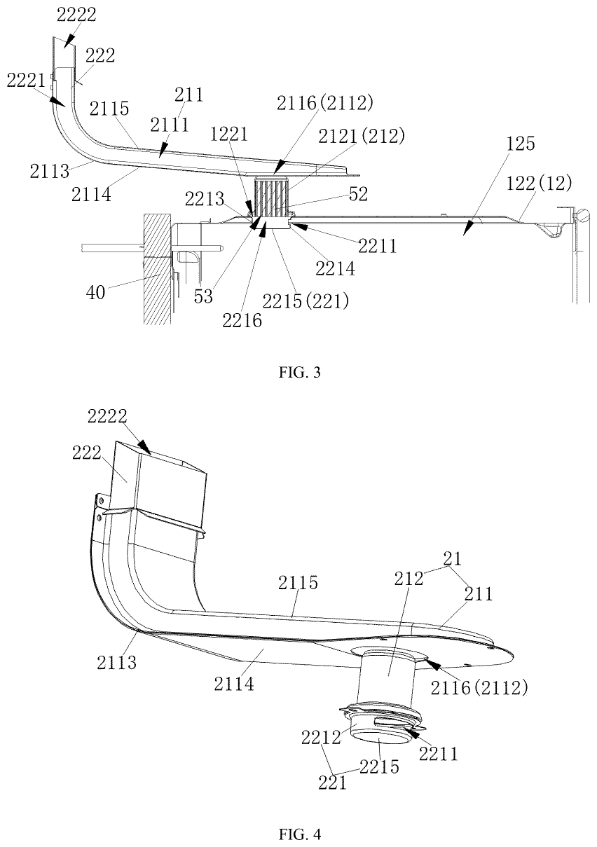

In some embodiments, the baffle member includes a ventilation cover 221 covering the air outlet hole 1221. Referring to FIGS. 2 and 3, the ventilation covers 221 is installed on the external discharge connecting member 122 formed by the top plate. The ventilation covers 221 includes a baffle side wall 2212 and a sinking bottom wall 2215. The baffle side wall 2212 protrudes on the inner side of the external discharge connecting member 122, and the sinking bottom wall 2215 is connected to an end of the baffle side wall 2212 away from the top plate and is arranged opposite to the air outlet hole 1221 formed on the top plate. The baffle side wall 2212 and the sinking bottom wall 2215 together adjacent to form a purification cavity 2216. The external leakage gap includes a first leakage gap 2211 formed on the baffle side wall 2212 of the ventilation cover 221. The cooking cavity 125, the first leakage gap 2211, the purification cavity 2216, the air outlet hole 1221, and the external discharge channel are communicated in sequence. The ventilation covers 221 forms a boss structure protruding from the side of the top plate adjacent to the bottom plate 124. For the hot air flowing along the blowing path, the boss structure makes the flow path of the hot air flow entering the air outlet hole 1221 and then flowing into the external discharge channel more tortuous and complex. In other words, the hot air flowing along the blowing path is not easy to be discharged outward, which slows down the external discharge rate of the hot air flow. As the number of circulations of the hot air flow in the cooking apparatus increases, the temperature and the air pressure in the cooking cavity 125 gradually rise, and a part of the hot air flow is squeezed to the inner side of the external discharge connecting member 122. At this time, the hot air flow attached to the inner side of the external discharge connecting member 122 will pass through the first leakage gap 2211 to enter the purification cavity 2216, and then enter the air outlet hole 1221 and the external discharge channel.

Referring to FIGS. 3 and 4, in some embodiments, the baffle side wall 2212 includes a front part 2214 and a rear part 2213. the front part 2214 of the baffle side wall 2212 is a part of the baffle side wall 2212 away from the hot air unit 30 and the hot air baffle 11, and the rear part 2213 of the baffle side wall 2212 is a part of the baffle side wall 2212 adjacent to the hot air unit 30 and the hot air baffle 11. The first leakage gap 2211 is entirely formed on the front part 2214 of the baffle side wall 2212. Therefore, the hot air flowing along the blowing path will first reach the rear part 2213 of the baffle side wall 2212, then the hot air flow will bypass the ventilation cover 221 and continue to flow forward for a certain distance in the direction away from the hot air unit 30 and the hot air baffle 11. In other words, even if the hot air flowing along the blowing path reaches the surface of the baffle side wall 2212, it will not enter the first leakage gap 2211 immediately. Only when the air pressure in the cooking cavity 125 rises to a certain level, a part of the hot air flow will be squeezed to the front part 2214 of the baffle side wall 2212 to enter the first leakage gap 2211. In this way, the hot air flow can be intermittently flowed into the external discharge channel through the first leakage gap 2211, that is, after the hot air flow circulates several times between the hot air cavity 41 and the cooking cavity 125, a part of the hot air flow will be discharged. After the air pressure in the cooking cavity 125 drops slightly, the external discharge of the hot air flow is suspended until the hot air flow circulates several times again between the hot air cavity 41 and the cooking cavity 125, and then a part of the hot air flow continues to be discharged.

In some other embodiments, the first leakage gap 2211 includes a rear leakage gap formed on the rear part 2213 of the baffle side wall 2212 and a front leakage gap formed on the front part 2214 of the baffle side wall 2212. An opening size of the front leakage gap is greater than that of the rear leakage gap. In this way, among the hot air flow entering the first leakage gap 2211 and then entering the external discharge channel, most of them are squeezed into the front leakage gap as the air pressure in the cooking cavity 125 increases, and only a less amount of hot air flowing along the blowing path enters the rear leakage gap. Therefore, it can also prevent the newly generated hot air flow from being discharged too early and too much.

Optionally, referring to FIGS. 2 and 3, the purification assembly further includes a second purification member 52. At least a part of the second purification member 52 is arranged in the purification cavity 2216. The part of the second purification member 52 located in the purification cavity 2216 is matched with the inner wall of the purification cavity 2216, and is provided with ventilation holes 53 which is in communication with the purification cavity 2216 and the external discharge channel. In this way, all the hot air flow entering the purification cavity 2216 from the first leakage gap 2211 can be purified and deodorized by the second purification member 52. Before the hot air flow enters the external discharge channel and becomes waste gas flow, the hot air flow is filtered again by the second purification member 52 to remove odor components, so that the odor concentration of the waste gas flow finally discharged outside of the cooking apparatus is further reduced, so as to alleviate the irritation to the mouth and nose of the user, and further reduce the impact of the waste gas flow on the environment.

In an embodiment, the hot air flow located on the rear part 2213 of the baffle side wall 2212 and attached to the inner side of the external discharge connecting member 122 can only enter the first leakage gap 2211 after bypassing the ventilation cover 221 and reaching the front part 2214 of the baffle side wall 2212. In contrast, the hot air flow located on the front part 2214 of the baffle side wall 2212 and attached to the inner side of the external discharge connecting member 122 is relatively easier to enter the first leakage gap 2211. Taking the top plate as the external discharge connecting member 122 as an example, the opening of the first leakage gap 2211 faces away from the hot air baffle 11 and the hot air unit 30, while the opening of the air outlet hole 1221 is arranged toward the bottom plate 124. That is, the opening direction of the first leakage gap 2211 is perpendicular to that of the air outlet hole 1221. Therefore, the hot air flow, after entering the first leakage gap 2211, needs to turn to enter the air outlet hole 1221. Of course, not only does the baffle side wall 2212 include a blocking effect on the hot air flow, but the second purification member 52 also includes a blocking and speed-reducing effect on the hot air flow.

Furthermore, referring to FIGS. 2 and 5, regardless of whether the first side plate 121, the top plate or the second side plate 123 is provided with the air outlet hole 1221 and used as the external discharge connecting member 122, the external discharge connecting member 122 includes a front end and a rear end opposite to each other. The front end of the external discharge connecting member is arranged 122 away from the hot air baffle 11 and the hot air unit 30, and the rear end of the external discharge connecting member is arranged 122 adjacent to the hot air baffle 11 and the hot air unit 30. The front end of the external discharge connecting member is used to form the edge of the inner container opening. The distance between the air outlet hole 1221 and the front end of the external discharge connecting member is greater than the distance between the air outlet hole 1221 and the rear end of the external discharge connecting member. In this way, the air outlet hole 1221 are located in a dead corner position away from the blowing path in the cooking cavity 125. After passing through the hot air baffle 11 and entering the cooking cavity 125, the hot air flow can avoid the air outlet hole 1221 and the ventilation cover 221, and immediately flow along the blowing path, ensuring that the newly generated hot air flow will not enter the external discharge channel too early. When the top plate is provided with the air outlet hole 1221 and used as the external discharge connecting member 122, referring to FIG. 5, the distance between the first side plate 121 and the air outlet hole 1221 or the distance between the first side plate 121 and the ventilation covers 221 is defined as a₁. The distance between the second side plate 123 and the air outlet hole 1221 or or the distance between the second side plate 123 and the ventilation covers 221 is defined as a₂. The distance a₁ between the first side plate and the air outlet hole is not equal to the distance a₂ between the second side plate and the air outlet hole. In this way, the distance between the hot air flowing along the blowing path and the air outlet hole 1221 or the distance between the hot air flowing along the blowing path and the ventilation covers 221 is farther, and the newly generated hot air flow can smoothly avoid the first leakage gap 2211 and the air outlet hole 1221 to prevent being discharged too early and too fast.

In some embodiments, the flow guide member 21 includes a buffer pipe 211 connected to the outer side of the external discharge connecting member 122. The external discharge channel includes a buffer cavity 2111 formed in the buffer pipe 211. The baffle member further includes a bent pipe 222 connected to the buffer pipe 211 in a bent manner. The external leakage gap further includes a second leakage gap 2221 formed in the bent pipe 222. The cooking cavity 125, the air outlet hole 1221, the buffer cavity 2111, and the second leakage gap 2221 are communicated in sequence. In this way, the hot air flow entering the buffer cavity 2111 from the cooking cavity 125 can finally be discharged outside of the cooking apparatus through the second leakage gap 2221. The hot air flow entering the buffer pipe 211 is referred to as waste gas flow. The bent pipe 222 serving as the baffle member is located at an end of the exhaust path. When the waste gas flows from the buffer cavity 2111 to the second leakage gap 2221, it will be blocked by the inner wall surface of the bent pipe 222 and turn, so the bent pipe 222 can inhibit the waste gas flow from entering the second leakage gap 2221 and being discharged outward too fast. By means of the bent pipe 222, the waste gas flow gradually fills the buffer cavity 2111 and stays in the buffer cavity 2111 for a longer time, and also increases the air pressure in the buffer cavity 2111 gradually. The increase of the internal air pressure of the buffer cavity 2111 can slow down the rate at which the hot air flow enters the buffer cavity 2111 from the cooking cavity 125, thereby increasing the number of circulations and the residence time of the hot air flow in the cooking apparatus.

In an embodiment, the flow guide member 21 further includes a pipe connecting member 212 connected to the buffer pipe 211 in a bent manner. An end of the pipe connecting member 212 away from the external discharge connecting member 122 is connected to the outer side of the external discharge connecting member 122, and one end of the bent pipe 222 is connected to the buffer pipe 211, the other end of the waste gas flow passage 2121 formed in the pipe connecting member 212 is in communication with the buffer cavity 2111 and the air outlet hole 1221, respectively. In this way, the inner side of the external discharge connecting member 122, the pipe connecting member 212 and the buffer pipe 211 form a more tortuous exhaust path. The hot air flow flows along the inner side of the external discharge connecting member 122, the air outlet hole 1221, the waste gas flow passage 2121, the buffer cavity 2111, the second leakage gap 2221, and is finally discharged from the exhaust port 2222. During this process, the hot air flow turns at least three times: the first turn occurs when entering the air outlet hole 1221, the middle turn occurs when entering the buffer cavity 2111 from the waste gas flow passage 2121, and the last turn occurs when entering the second leakage gap 2221 from the buffer cavity 2111. The flow velocity of the hot air flow is significantly attenuated, which increases the difficulty for the hot air flow to enter the buffer cavity 2111 from the cooking cavity 125, thus helping to increase the number of circulations and the residence time of the hot air flow in the cooking apparatus.

Referring to FIGS. 3 and 4, the top plate of the cooking-chamber assembly 12 serves as the external discharge connecting member. The buffer pipe 211 is a flat tubular structure, including a first pipe wall 2114 and a second pipe wall 2115 arranged at intervals. The buffer cavity 2111 is formed between the first pipe wall 2114 and the second pipe wall 2115. The first pipe wall 2114 is provided with a side inlet 2116, and the second pipe wall 2115 is located on the side of the first pipe wall 2114 away from the external discharge connecting member 122. The end of the pipe connecting member 212 away from the external discharge connecting member 122 is hermetically connected to the opening edge of the side inlet 2116, so that the buffer cavity 2111 is in communication with the waste gas flow passage 2121 thought the side inlet 2116, and thus the opening edge of the side inlet 2116 forms the first pipe connecting portion 2112. The distance between the buffer cavity 2111 and the external discharge connecting member 122 increases from the first pipe connecting portion 2112 to the second pipe connecting member 2113. The distance between the buffer cavity 2111 and the external discharge connecting member 122 is the distance from the side of the first pipe wall 2114 toward the second pipe wall 2115 to the external discharge connecting member 122, so that an angle is formed between the extending direction of the buffer cavity 2111 and the extending direction of the external discharge connecting member 122. The angle is in a range of greater than or equal to 3 degrees to less than or equal to 8 degrees.

In this way, the waste gas flow entering the buffer cavity 2111 includes a tendency to spontaneously flow from the first pipe connecting portion 2112 to the second pipe connecting member 2113, in order to approach the second leakage gap 2221. This is because the waste gas flow carries heat, so the waste gas flow includes an upward acceleration in the room temperature environment, and the waste gas flow just floats upward while flowing from the first pipe connecting portion 2112 to the second pipe connecting member 2113. Therefore, the buffer pipe 211 can effectively prevent the waste gas flow from backflowing from the buffer cavity 2111 to the cooking cavity 125. The angle between a range of greater than or equal to 3 degrees to less than or equal to 8 degrees ensures that the waste gas flow flows to the second leakage gap 2221 at a slow and stable rate, which helps to maintain the stability of the internal air pressure of the buffer cavity 2111. It will neither cause the waste gas flow to backflow into the cooking cavity 125 due to the rise of the internal air pressure of the buffer cavity 2111, nor cause the hot air flow in the cooking cavity 125 to enter the buffer cavity 2111 too early and too fast due to the drop of the internal air pressure of the buffer cavity 2111.

Optionally, referring to FIG. 3, the purification assembly further includes a second purification member 52, and at least a part of the second purification member 52 is arranged inside the waste gas flow passage 2121. The part of the second purification member 52 located inside the waste gas flow passage 2121 is matched with the inner wall of the waste gas flow passage 2121, and is provided with the ventilation holes 53 which is in communication with the cooking cavity 125 and the buffer cavity 2111. When the waste gas flows through the ventilation holes 53, the odor components in the waste gas flow are filtered and adsorbed by the second purification member 52. In this way, the waste gas flow can be purified and deodorized by the second purification member 52 before entering the buffer cavity 2111, so that the odor concentration of the waste gas flow finally discharged to the outside of the cooking apparatus is further reduced, which can alleviate the irritation of the waste gas flow to the user's mouth and nose, and reduce the pollution of the waste gas flow to the environment.

In some embodiments, the second purification member 52 can chemically react with odor components, and the hot air flowing through the second purification member 52 can increase the chemical reaction rate between the second purification member 52 and the odor components and catalyze the reaction. In some other embodiments, the second purification member 52 can physically adsorb and retain odor components, and the temperature of the hot air flow can improve the activity of the second purification member 52, thereby improving the retention and adsorption capacity of the second purification member 52 for odor components.

Optionally, referring to FIGS. 3 and 4, the cross-sectional area of the second leakage gap 2221 decreases from the second pipe connecting member 2113 to the exhaust port 2222. The second pipe connecting member 2113 includes a pipe section with an arc-shaped tubular structure. The buffer cavity 2111 is in communication with the second leakage gap 2221 through the inner cavity of the second pipe connecting member 2113 and realize arc transition. In this way, after the waste gas flow enters the second leakage gap 2221 from the inner cavity of the second pipe connecting member 2113, it can quickly flow outward with a less flow rate and a high flow velocity, so as to ensure that the waste gas flow is discharged smoothly outward, avoid blockage when the waste gas flow flows outward, and thus prevent the air pressure in the buffer cavity 2111 from rising suddenly and causing backflow of the waste gas flow. In the case where the top plate is used as the external discharge connecting member 122, the bent pipe 222 extending upward in the direction away from the external discharge connecting member 122 can guide the waste gas flow upward so that the waste gas flow can be absorbed by the range hood located above the cooking apparatus.

Optionally, referring to FIG. 4, the distance between the first pipe wall 2114 and the second pipe wall 2115 is less than the width of the first pipe wall 2114 and the second pipe wall 2115, and the width of the first pipe wall 2114 and the second pipe wall 2115 is not less than twice the diameter of the side inlet 2116. In this way, the buffer pipe 211 is generally closer to a flat tubular structure, and the buffer cavity 2111 is a flat cavity. After the waste gas flow enters the buffer cavity 2111 through the waste gas flow passage 2121, it immediately collides with the second pipe wall 2115 head-on, so that the flow velocity of the waste gas flow is greatly reduced. The waste gas flow then diffuses and overflows laterally along the first pipe wall 2114 to gradually fill the buffer cavity 2111, which can prevent the waste gas flow from entering the second leakage gap 2221 too early and too fast, and enable the buffer cavity 2111 to maintain a high-pressure state for a long time. On the whole, the air pressure in the buffer cavity 2111 is approximately equal to or slightly less than the air pressure in the cooking cavity 125, but greater than the ambient air pressure outside the cooking apparatus. In other words, a gradually decreasing air pressure distribution is generally established from the cooking cavity 125 to the buffer cavity 2111, and then to the external environment of the cooking apparatus.

Furthermore, since the odor components in the food materials will diffuse into the hot air flow, and the diffusion amount will increase with the rise of the number of circulations of the hot air flow in the cooking apparatus, resulting in the hot air flow being pungent and unpleasant, the purification assembly further includes a first purification member 51 arranged in the hot air cavity 41. In this way, the return air flow entering the hot air cavity 41 and the air accumulated in the hot air cavity 41 can be filtered by the first purification member 51 to remove odor components, so that the concentration of odor components in the newly generated hot air flow in the hot air cavity 41 is reduced. Through the purification and deodorization of the hot air flow by the first purification member 51, the hot air discharged from the cooking apparatus will not easily bring a strong pungent feeling to the user, and the impact of the discharged hot air on the environment is reduced.

Referring to FIG. 2, in some embodiments, the first purification member 51 is arranged on the outer peripheral side of the fan 31. The fan 31 includes a main body member and fan blades connected to the main body part. The main body member is arranged opposite to the air return portion. The hot air unit 30 further includes a driving member connected to the main body member of the fan 31. The driving member can drive the fan 31 to rotate around a preset rotation center, and the preset rotation center serves as the rotation axis of the fan 31. The outer peripheral side of the fan 31 includes the ends of the fan blades away from the preset rotation center. When the fan 31 rotates, it will suck air to make the air flow back adjacent to the main body member along the extending direction of the preset rotation center, and then the sucked air is pushed by the fan blades to accelerate, and finally the air is thrown out of the ends of the fan 31 under the centrifugal effect. Therefore, the outer peripheral side of the fan 31 composed of the ends of the fan blades is the air outlet member of the fan 31. After the air flow leaves the fan 31, it will flow to the first purification member 51 and be filtered by the first purification member 51 to remove odor components, and then the air flow will be blown to the cooking cavity 125 as hot air flow.

Specifically, referring to FIG. 2, the heating element 32 is located on the outer peripheral side of the fan 31, and the first purification member 51 is located on the side of the heating element 32 away from the fan 31. In this way, after the air flow is thrown out of the fan 31, it first flows through the heating element 32 and is heated by the heating element 32 to become hot air flow, and then the hot air flow flows through the first purification member 51 and is filtered by the first purification member 51 to remove odor components. In other words, the first purification member 51 purifies the air flow carrying heat, and the higher temperature can improve the efficiency of the first purification member 51 in filtering odor components.

In some embodiments, the first purification member 51 can chemically react with odor components, and the hot air flowing through the first purification member 51 can increase the chemical reaction rate between the first purification member 51 and the odor components and catalyze the reaction. In some other embodiments, the first purification member 51 can physically adsorb and retain odor components, and the temperature of the hot air flow can improve the activity of the first purification member 51, thereby improving the retention and adsorption capacity of the first purification member 51 for odor components.

Optionally, referring to FIG. 2, the heating element 32 is a heating tube, which includes a closed-loop pipe section surrounding the fan 31 along the circumferential direction of the rotation axis of the fan 31. The first purification member 51 includes a closed-loop structure and circumferentially surrounds the outer peripheral side of the closed-loop pipe section along the rotation axis of the fan 31. That is, the first purification member 51 itself has a hollow area, and both the fan 31 and the closed-loop pipe section are accommodated in the hollow area of the first purification member 51. Optionally, the closed-loop pipe section and the first purification member 51 are both circular ring structures, and the closed-loop pipe section, the first purification member 51 and the fan 31 are coaxially arranged. The rotation axis of the fan 31 coincides with the axis of the closed-loop pipe section and also coincides with the axis of the first purification member 51. In this way, the air thrown out from all radial directions of the fan 31 can be heated by the heating element 32, and the air thrown out from all radial directions of the fan 31 can be filtered by the first purification member 51 to remove odor components, so that the purification and deodorization effect is improved, and a part of the hot air flow is prevented from missing the first purification member 51.

In some embodiments, referring to FIG. 2, two ends of the first purification member 51 are abutted against the leeward side of the hot air baffle 11 and the side of the back plate 40 toward the hot air baffle 11, respectively. Therefore, one end of the hollow area of the first purification member 51 is covered by the hot air baffle 11, and the other end of the hollow area of the first purification member 51 is covered by the back plate 40. Correspondingly, the first purification member 51 is provided with the ventilation holes 53, which penetrate through the side of the first purification member 51 adjacent to the fan 31 and also penetrate through the side of the first purification member 51 away from the fan 31.

In this way, the first purification member 51, the hot air baffle 11 and the back plate 40 together adjacent to form a closed space area. The closed space area is only in communication with the cooking cavity 125 through the air return holes 111, and the closed space area is only in communication with the hot air cavity 41 located outside the first purification member 51 through the ventilation holes 53 of the first purification member 51. This means that the return air flow entering the closed space area and the air accumulated in the closed space area can only diffuse to the area of the hot air cavity 41 outside the first purification member 51 through the ventilation holes 53 of the first purification member 51, ensuring that all the hot air flow thrown out of the fan 31 can flow through the first purification member 51 to be fully filtered by the first purification member 51 to remove odor components, thus significantly improving the deodorization and purification effect.

The ventilation holes 53 may be mesh holes extending along the radial direction of the first purification member 51, and the mesh holes are evenly distributed along the circumferential direction of the first purification member 51. One end of each ventilation hole 53 adjacent to the rotation axis of the fan 31 penetrates through the inner peripheral side of the first purification member 51, and the inner peripheral side of the first purification member 51 is the side of the first purification member 51 adjacent to the fan 31 and the heating element 32. The other end of each ventilation hole 53 away from the rotation axis of the fan 31 penetrates through the outer peripheral side of the first purification member 51. The outer peripheral side of the first purification member 51 is the other side of the first purification member 51 away from the fan 31 and the heating element 32. In this way, the ventilation holes 53 are numerous and densely distributed, and the inner wall surface of the ventilation holes 53 serves as the main surface of the first purification member 51 for filtering odor components, which significantly increases a contact area between the first purification member 51 and the hot air flow.

Referring to FIGS. 1 and 5, in some embodiments, a member of the hot air baffle 11 protrudes relative to the back plate 40 along the rotation axis of the fan 31 and extends into the inner passage, so that at least the baffle portion is located in the inner passage. The hot air baffle 11 further includes a flange portion, which is connected to the outer peripheral edge of the baffle portion in a bent manner and protrudes from the side of the baffle portion toward the back plate 40. An end of the flange portion away from the outer peripheral edge of the baffle portion is connected to the back plate 40. The flange portion and the inner wall surface of the inner passage are arranged at intervals. The blowing holes include a side blowing hole 112 formed in the flange portion, and the openings of the side blowing hole 112 face the inner wall surface of the inner passage. Optionally, the flange portion is a closed-loop structure extending along the outer peripheral edge of the baffle portion, surrounding the baffle portion, and circumferentially surrounding the hot air unit 30 along the rotation axis of the fan 31. The outer peripheral side of the first purification member 51 faces the inner peripheral wall of the flange portion.

Specifically, referring to FIG. 1, the outer peripheral edge of the baffle portion is approximately octagonal, including a first side edge, a first inclined edge, a top edge, a second inclined edge, a second side edge, a third inclined edge, a bottom edge, and a fourth inclined edge sequentially arranged along the circumferential direction of the rotation axis of the fan 31. The flange portion includes a first side flange 1131 connected to the first side edge in a bent manner, a first inclined flange 1135 connected to the first inclined edge in a bent manner, a top flange 1132 connected to the top edge in a bent manner, a second inclined flange 1136 connected to the second inclined edge in a bent manner, a second side flange 1133 connected to the second side edge in a bent manner, a third inclined flange 1137 connected to the third inclined edge in a bent manner, a bottom flange 1134 connected to the bottom edge in a bent manner, and a fourth inclined flange 1138 connected to the fourth inclined edge in a bent manner. The side of the first side plate 121 toward the second side plate 123 is arranged opposite to the first side flange 1131 at intervals, the side of the top plate toward the bottom plate 124 is arranged opposite to the top flange 1132 at intervals, the side of the second side plate 123 toward the first side plate 121 is arranged opposite to the second side flange 1133 at intervals, and the side of the bottom plate 124 toward the top plate is arranged opposite to the bottom flange 1134 at intervals. The two ends of the first inclined flange 1135 are respectively connected to the first side flange 1131 and the top flange 1132, and the side of the first inclined flange 1135 away from the hot air unit 30 faces the included angle between the first side plate 121 and the top plate. The two ends of the second inclined flange 1136 are respectively connected to the top flange 1132 and the second side flange 1133, and the side of the second inclined flange 1136 away from the hot air unit 30 faces the included angle between the top plate and the second side plate 123. The two ends of the third inclined flange 1137 are respectively connected to the second side flange 1133 and the bottom flange 1134, and the side of the third inclined flange 1137 away from the hot air unit 30 faces the included angle between the second side plate 123 and the bottom plate 124. The two ends of the fourth inclined flange 1138 are respectively connected to the bottom flange 1134 and the first side flange 1131, and the side of the fourth inclined flange 1138 away from the hot air unit 30 faces the included angle between the bottom plate 124 and the first side plate 121.

Optionally, referring to FIGS. 1 and 5, the side blowing hole 112 are formed in any one or more of the first side flange 1131, the top flange 1132, the second side flange 1133, and the bottom flange 1134. None of the first inclined flange 1135, the second inclined flange 1136, the third inclined flange 1137, and the fourth inclined flange 1138 is provided with the side blowing hole 112. In this way, it not only does not affect the hot air flow passing through the hot air baffle 11 and blowing to the cooking cavity 125, but also can inhibit the hot air flow from flowing to the dead corner area of the inner wall surface of the inner passage, so that the hot air flow along the blowing path avoids the air outlet hole 1221, and the air outlet hole 1221 are usually formed in the dead corner area of the inner wall surface of the inner passage, thereby helping to increase the number of circulations of the hot air flow. The dead corners of the inner wall surface include the included angle between the first side plate 121 and the top plate, the included angle between the top plate and the second side plate 123, the included angle between the second side plate 123 and the bottom plate 124, and the included angle between the bottom plate 124 and the first side plate 121. Especially in the case where the air outlet hole 1221 are formed in the area of the top plate adjacent to the hot air baffle 11 and the first side plate 121, the first inclined flange 1135 can inhibit the hot air flow from flowing to the air outlet hole 1221 and prevent the hot air flow from entering the external discharge channel from the air outlet hole 1221 too early and too fast and being discharged out of the cooking apparatus, thereby increasing the number of circulations of the hot air flow. It can be understood that when the top plate is used as the external discharge connecting member 122 and the air outlet hole 1221 are formed in the area of the top plate adjacent to the hot air baffle 11 and the first side plate 121, the distance between the air outlet hole 1221 and the front end of the external discharge connecting member of the top plate is greater than the distance between the air outlet hole 1221 and the rear end of the external discharge connecting member of the top plate, the distance between the first side plate 121 and the air outlet hole 1221 is defined as a₁, the distance between the second side plate 123 and the air outlet hole 1221 is defined as a₂, and the distance a₁ between the first side plate 121 and the air outlet hole 1221 is less than the distance a₂ between the second side plate 123 and the air outlet hole 1221. The front end of the external discharge connecting member of the top plate is an end of the top plate away from the hot air unit 30 and the hot air baffle 11, and the rear end of the external discharge connecting member of the top plate is an end of the top plate adjacent to the hot air unit 30 and the hot air baffle 11. Of course, the distance a₁ between the first side plate 121 and the air outlet hole 1221 can also be greater than the distance a₂ between the second side plate 123 and the air outlet hole 1221, and in this case, the second inclined flange 1136 plays a role in inhibiting the hot air flow from flowing to the air outlet hole 1221.

Optionally, in some embodiments, the blowing holes further include direct blowing holes formed in the baffle portion, and the hot air flow passing through the direct blowing holes can be directly blown to the cooking cavity 125 and then directly flow to the inner container opening. In contrast, due to Coanda effect of the fluid, the hot air flow passing through the side blowing hole 112 mainly flows along the inner wall surface of the inner passage. Therefore, the hot air flow passing through the direct blowing holes is configured for directly baking the food materials, while the hot air flow passing through the side blowing hole 112 is mostly used to form a hot flow field occupying the cooking cavity 125, which surrounds the food materials. The above two types of hot air flows cooperate to ensure that the food materials are fully heated and cooked. The side blowing hole 112 formed in the flange portion are more convenient for the hot air flow to pass through. After being thrown out of the fan 31, the hot air flow has a radial velocity vector flowing along the radial direction of the rotation axis of the fan 31. With the radial velocity vector, most of the hot air flow is directly blown to the inner side of the flange portion toward the hot air unit 30, and then directly passes through the side blowing hole 112 until reaching the inner wall surface of the inner passage. Of course, the direct blowing holes on the baffle portion can also be eliminated.

Furthermore, regardless of whether the blowing holes are direct blowing holes formed in the baffle portion, side blowing hole 112 formed in the flange portion, or both direct blowing holes and side blowing hole 112, the shortest distance from the blowing holes to the rotation axis is not less than the longest distance from the first purification member 51 to the rotation axis. Referring to FIG. 2, the distance between the side blowing hole 112 formed in the flange portion and the rotation axis of the fan 31 is greater than the distance between the outer peripheral side of the first purification member 51 and the rotation axis of the fan 31. If the blowing side of the hot air baffle 11 is observed from a viewing direction parallel to the rotation axis of the fan 31, referring to FIG. 1, the orthographic projection of the blowing holes on the parallel plane of the hot air baffle 11 is an air outlet opening projection, the orthographic projection of the first purification member 51 on the parallel plane of the hot air baffle 11 is a deodorization position projection, and the orthographic projection of the air return holes 111 on the parallel plane of the hot air baffle 11 is an air return opening projection. It is specified that the parallel plane of the hot air baffle 11 is parallel to the hot air baffle 11 and perpendicular to the rotation axis of the fan 31. Then the deodorization position projection is a closed-loop figure, the air outlet opening projection is entirely located outside the deodorization position projection, and the air return opening projection is entirely located inside the deodorization position projection. In this way, all the return air flow entering the hot air cavity 41 through the air return holes 111 passes through the first purification member 51 before reaching the outer peripheral side of the first purification member 51, and all the hot air flow blown to the cooking cavity 125 from the blowing holes passes through the first purification member 51.

The cooking apparatus of the present disclosure adopts the form of arranging the first purification member 51 in the hot air cavity 41. When a user takes food materials out of the cooking cavity 125 or puts food materials into the cooking cavity 125, the user will not be interfered by the first purification member 51. At the same time, the first purification member 51 is prevented from being contaminated by food materials, so that the first purification member 51 can maintain cleanliness for a longer time without frequent cleaning or replacement.

Compared with the related art, the beneficial effects of the cooking apparatus of the present disclosure at least include: 1) the cooking cavity is in communication with the outside of the cooking apparatus through the external discharge channel and the external leakage gap, allowing the hot air flow to be discharged out of the cooking apparatus along the exhaust path, preventing a sharp increase in air pressure inside the cooking cavity, and reducing the risk of the user being scalded by the hot air flow when opening the cooking cavity to take food; 2) the baffle member arranged on the exhaust path blocks and disturbs the hot air flow, slows down the speed at which the hot air flow is discharged out of the cooking apparatus along the exhaust path, and increases the number of circulations of the hot air flow between the hot air unit and the cooking cavity, avoiding waste caused by the hot air flow being discharged out of the cooking apparatus too fast and too early, and improving the utilization rate of heat carried in the hot air flow; 3) the residence time of the hot air flow in the cooking apparatus is prolonged, preventing temperature and heat fluctuations in the cooking cavity caused by too fast discharge of the hot air flow, helping to reduce the frequency of starting the hot air unit to heat air, and lowering the total power consumption required for generating the hot air flow.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

What is claimed is:

1. A cooking apparatus, comprising a heat-gathering unit and an external discharge unit, wherein the heat-gathering unit comprises an external discharge connecting member and is provided with a cooking cavity formed on an inner side of the external discharge connecting member; the external discharge unit comprises a flow guide member and a baffle member, the flow guide member is connected to the external discharge connecting member and is provided with an external discharge channel, the external discharge connecting member and the flow guide member form an exhaust path, the baffle member is arranged on the exhaust path and is provided with an external leakage gap,
the external leakage gap is in communication with the cooking cavity and the external discharge channel; and/or, the external leakage gap is in communication with the external discharge channel and an outside of the cooking apparatus.

2. The cooking apparatus of claim 1, wherein the external discharge connecting member is provided with an air outlet hole in communication with the external discharge channel, the baffle member comprises a ventilation cover covering the air outlet hole, the ventilation cover comprises a baffle side wall protruding from the inner side of the external discharge connecting member, the external leakage gap comprises a first leakage gap formed on the baffle side wall of the ventilation cover, and the first leakage gap is in communication with the cooking cavity and the air outlet hole.

3. The cooking apparatus of claim 2, further comprising a hot air unit, wherein a part of the baffle side wall adjacent to the hot air unit forms a rear part of the baffle side wall, a part of the baffle side wall away from the hot air unit forms a front part of the baffle side wall, and
the first leakage gap is entirely formed on the front part of the baffle side wall; or
the first leakage gap comprises a rear leakage gap formed on the rear part of the baffle side wall and a front leakage gap formed on the front part of the baffle side wall, and an opening size of the front leakage gap is greater than that of the rear leakage gap.

4. The cooking apparatus of claim 3, wherein the external discharge connecting member comprises a front end and a rear end, the front end of the external discharge connecting member is arranged away from the hot air unit, the rear end of the external discharge connecting member is arranged adjacent to the hot air unit, and a distance between the air outlet hole and the front end of the external discharge connecting member is greater than a distance between the air outlet hole and the rear end of the external discharge connecting member.

5. The cooking apparatus of claim 4, wherein the heat-gathering unit further comprises a first side plate and a second side plate, the first side plate, the external discharge connecting member and the second side plate are connected in sequence to enclose and form the cooking cavity, a distance between the first side plate and the air outlet hole is defined as a₁, a distance between the second side plate and the air outlet hole is defined as a₂, and the distance a₁ between the first side plate and the air outlet hole is not equal to the distance a₂ between the second side plate and the air outlet hole.

6. The cooking apparatus of claim 2, wherein the ventilation cover further comprises a sinking bottom wall arranged opposite to the air outlet hole, the baffle side wall extends along an outer peripheral edge of the sinking bottom wall and encloses with the sinking bottom wall to form a purification cavity, the purification cavity is in communication with the air outlet hole and the first leakage gap, and a purification member is arranged in the purification cavity.

7. The cooking apparatus of claim 1, wherein the flow guide member comprises a buffer pipe connected to the external discharge connecting member, the buffer pipe comprises a buffer cavity, the buffer cavity is in communication with the cooking cavity, and the buffer cavity is a part of the outer exhaust channel, the baffle member comprises a bent pipe connected to and in communication with the buffer pipe in a bent manner, the external leakage gap comprises a second leakage gap formed in the bent pipe, and the second leakage gap is in communication with the buffer cavity and the outside of the cooking apparatus.

8. The cooking apparatus of claim 7, wherein the flow guide member further comprises a pipe connecting member connected to the buffer pipe in a bent manner, an end of the pipe connecting member away from the buffer pipe is connected to the external discharge connecting member, the external discharge channel further comprises a waste gas flow passage formed in the pipe connecting member, and two ends of the waste gas flow passage are in communication with the buffer cavity and the cooking cavity, respectively.

9. The cooking apparatus of claim 8, wherein a purification member is arranged inside the waste gas flow passage.

10. The cooking apparatus of claim 7, wherein the buffer pipe comprises a first pipe connecting portion and a second pipe connecting portion, the external discharge connecting member and the bent pipe are connected to the first pipe connecting portion and the second pipe connecting portion, respectively, and a distance between the buffer cavity and the external discharge connecting member increases from the first pipe connecting portion to the second pipe connecting portion.

11. The cooking apparatus of claim 10, wherein an angle is formed between an extending direction of the buffer cavity and an extending direction of the external discharge connecting member, and the angle is in a range of greater than or equal to 3 degrees to less than or equal to 8 degrees.

12. The cooking apparatus of claim 7, wherein the bent pipe extends in a direction away from the external discharge connecting member; and/or,
the second leakage gap runs through the bent pipe and forms an exhaust port, and a cross-sectional area of the second leakage gap decreases from the buffer pipe to the exhaust port.

13. The cooking apparatus of claim 1, wherein the heat-gathering unit further comprises a hot air baffle connected to the external discharge connecting member, a hot air unit and a purification member are arranged on one side of the hot air baffle, and the cooking cavity is formed on the other side of the hot air baffle.
